(19) United States
(12) Patent Application Publication
(10) Pub. No.: US 2025/0342737 A1
(43) Pub. Date: Nov. 6, 2025

(54) Control of a Motor Vehicle

(71) Applicant: Bayerische Motoren Werke Aktiengesellschaft, Muenchen (DE)

(72) Inventors: Michael FURCHNER, Mering (DE); Marco Hippler, Muenchen (DE); Thorsten Knott, Tuntenhausen (DE); Daniel Kuelzer, Muenchen (DE); Lukas Reinhart, Freising (DE)

(21) Appl. No.: 19/190,968

(22) Filed: Apr. 28, 2025

(30) Foreign Application Priority Data
May 6, 2024 (DE) 10 2024 112 710.4

(51) Int. Cl. G07C 9/00; B60R 25/04; B60R 25/20

(52) U.S. Cl. CPC G07C 9/00817; B60R 25/04; B60R 25/209

(57) ABSTRACT

A method for controlling a motor vehicle includes detecting a request to lock addition of a newly created digital vehicle key that can be used to control the motor vehicle, determining that the request uses an existing and authorized digital vehicle key, and setting a lock that prevents validation of a newly created digital vehicle key or storage of it in the motor vehicle.

### CROSS REFERENCE TO RELATED APPLICATION

This application claims priority under 35 U.S.C. § 119 from German Patent Application No. 10 2024 112 710.4, filed May 6, 2024, the entire disclosure of which is herein expressly incorporated by reference.

### BACKGROUND AND SUMMARY

The present invention relates to control of a motor vehicle using a digital vehicle key. In particular, the invention relates to the addition of a newly created digital vehicle key.

A motor vehicle comprises a control unit configured to control specific security functions of the motor vehicle using a digital vehicle key. A digital vehicle key is stored in the control unit that authorizes control of the security function. The security function can comprise a central locking system or an immobilizer. Another part of the digital vehicle key can be stored on a user's device. The user can exhibit the digital vehicle key wirelessly to the motor vehicle to control the security function.

A new vehicle key can be added to the system by first creating it, and then digitally signing it with an authorized vehicle key. The new vehicle key is signed and stored in a key management system in the motor vehicle. The new vehicle key can then be presented to the vehicle to control security functions.

The process of creating and adding a new digital vehicle key can result in new access problems with regard to security. One of the objects of the present invention is therefore to create a better means for protecting a motor vehicle with a digital vehicle key. The invention solves this problem with the subject matter of the independent claims. Dependent claims describe preferred embodiments.

According to a first aspect of the invention, the method for controlling a vehicle comprises steps for detecting a command to prevent adding a newly created digital vehicle key that can be used to control the motor vehicle, determining that the command uses an existing digital vehicle key authorized for such, and setting a lock preventing validation of a newly created digital vehicle key, or storing it in the vehicle.

The digital vehicle key can be designed according to the proposals of the Car Connectivity Consortium. Technical specifications of the fundamental technology have been published. The intention of the invention is to ensure that no new digital vehicle keys can be used, created, or made able to control security functions for the vehicle. The addition is prevented by setting the aforementioned lock.

Control of the motor vehicle and communication with a device on which a user's digital vehicle key is stored usually take place in a motor vehicle's control unit. It can basically be said that these functions are implemented by the motor vehicle. Control of the motor vehicle using a digital vehicle key normally comprises control of specific security functions, in particular releasing central locking, overriding an immobilizer or starting a motor.

It is possible to prevent new digital vehicle keys from being added to an existing vehicle key in the vehicle by exiting the addition process for new digital vehicle keys. A vehicle key not stored in the vehicle cannot be used to control a security function. The storage can take place in a variety of ways and comprises sending an attestation package from the key management system to the motor vehicle.

Locking can be obtained in a variety of ways, and it is also possible to set numerous locks. These locks can also be combined. In one embodiment, a device on which an existing digital vehicle key is stored can be used to sign a newly created vehicle key, or to request the creation thereof, and can also be used to refuse to provide such a signature. If there are numerous vehicle keys, or such devices, it may be difficult to set locks for all vehicle keys, but such a lock can be used as a secondary security measure.

In another embodiment, the lock is set in the vehicle. In this case, storage of a newly created digital vehicle key in the vehicle is prevented. Storage normally involves sending an attestation package for the newly created vehicle key from the key management system. If the vehicle does not receive the attestation package, or refuses to process it, cryptographic data for the newly created vehicle key is not stored in the vehicle, and the new key cannot be used to control the motor vehicle.

In another embodiment, the key management system sets the lock. In this case, the key management system is prevented from signing the newly created digital vehicle key. Rejecting the digital cryptographic signature prevents creation of a valid attestation package.

In another embodiment, the lock prevents the key management system from creating an attestation package for a newly created digital vehicle key. The attestation package cannot be created, or an existing attestation package cannot be sent to the motor vehicle. Without sending the attestation package to the motor vehicle, it is impossible to use a newly created digital vehicle key therein.

A digital key authorized to set a lock can be assigned to a specific person. This person is also referred to as the proprietor (owner) according to the technical specifications from the CCC, even if other people, or in some cases a technological entity, can assume this role. A person for whom the new digital vehicle key has been created can be referred to as a friend.

The digital vehicle key for one person is normally stored on a device. This device is preferably a mobile device, and can also be a smart watch, smart band, a wearable device, or a head-mounted device. The key is also preferably stored in a protected memory in the device and can be configured to require authentication for access to the protected memory. The person can present a biometric feature or enter a predetermined code for this. Consequently, the person, device, and key are cryptographically interconnected.

It is also preferably determined that at least one digital vehicle key for controlling the motor vehicle exists with which the lock can later be deactivated. If such a digital vehicle key does not exist, it is also possible to not set a lock. The digital vehicle key for deactivating the lock should be stored in the vehicle. In general, all the digital vehicle keys belonging to a valid vehicle key are stored in the vehicle. It should be noted that it is not necessarily the case that every digital vehicle key stored in the vehicle can be used to deactivate the lock.

A lock can be deactivated using another existing vehicle key. A vehicle key with which a lock can be set can be a different key than that with which a lock can be deactivated. The vehicle keys could be assigned to different people and/or different devices.

A request to set a lock can be issued by different individuals. In a first variation, the request is created in response to a direct interaction with the motor vehicle. Someone can use an operating element in the vehicle to do this. A digital vehicle key used for creating the request can be near the vehicle. The vehicle key can be checked wirelessly by the vehicle. In this case, the lock can be set immediately.

It is also possible for the vehicle to send a request to set a lock to the key management system to obtain a signature for a newly created key, or an attestation package for the vehicle. If the vehicle is temporarily unable to send a request to the key management system for some reason, the request to the key management system for this lock may be delayed.

In another variation, the request is made in response to input on a device in which the authorized vehicle key is stored. The device is normally a mobile device that can be assigned to a specific person, in particular the owner of the motor vehicle. In this case, the mobile device does not have to be in the motor vehicle. The request can be sent directly to the key management system, and the key management system can send back confirmation of the lock. A request to set a lock by the motor vehicle can either be sent by the device or the key management system in the motor vehicle.

A third variation relates to a central office from which the request is issued. The central office can be operated by a motor vehicle manufacturer, for example. Consequently, an owner who can verify legal status regarding the motor vehicle can set a lock. The central office can then issue a request to set a lock to the key management system and/or the motor vehicle. In one embodiment, the central office is integrated in the key management system.

The motor vehicle is preferably instructed to reject a digital vehicle key after a lock has been set, and before the lock has been deactivated. This prevents a digital key that has been generated while there is a lock in the motor vehicle from automatically requesting validation after deactivating the lock.

In a particularly preferred embodiment, the key management system and motor vehicle each have a counter. The counter can function in arbitrary units, and is configured only to advance, and never to retreat. The counter advances when a lock has been set, and if a lock is deactivated. The key management system preferably assigns a current reading to the storage of a vehicle key. The motor vehicle can refuse to store a vehicle key if the counter reading is lower than the current reading in the motor vehicle.

This may cause the setting or deactivating of a lock to be delayed on the part of the motor vehicle. The counter for the key management system is preferably synchronized with the counter in the motor vehicle when a lock is deactivated.

When a motor vehicle is reset to the manufacturer's settings, a lock is deactivated. This relates to a complete reset of the motor vehicle to the initial settings for the motor vehicle. This may result of any security measures, user settings, learned values or acquired data being reset to predetermined values. This does not involve creation of a newly created digital vehicle key but does allow for a new key to be created.

According to another aspect of the present invention, a mobile device for controlling a motor vehicle has a user interface for inputting a request to block addition of a newly created digital vehicle key that can be used to control the motor vehicle, a communication system for communicating with a key management system or the vehicle, a protected memory in which existing digital vehicle keys are stored, and a processor. This processor is configured to receive input and respond, using the vehicle key, by issuing a request to set a lock to the key management system and/or the motor vehicle, to prevent validation of a newly created digital vehicle key, or the storage thereof in the motor vehicle.

The processor can also send a request to the key management system to set another lock. A local lock can also be set to prevent signing of a newly created key by the mobile device.

According to another aspect of the present invention, a device for controlling a motor vehicle has a user interface for inputting a request to block addition of a newly created digital vehicle key that can be used to control the motor vehicle, an interface for communication with a mobile device in which an existing digital vehicle key for the motor vehicle is stored, and a processor. This processor is configured to check the digital vehicle key and prevent storage of a newly created digital key in the motor vehicle. The device is in the motor vehicle, and preferably a permanent part thereof.

The device may also be able to issue a request for a lock to the key management system. If it is temporarily impossible to issue this request, it can be issued at a later time, e.g., when communication with the key management system can be resumed.

According to another aspect of the present invention, a motor vehicle is obtained that has the control unit described herein. The motor vehicle is preferably a motorcycle or passenger automobile. The motor vehicle could also be a truck or bus.

According to another aspect of the present invention, there is a key management system for a digital vehicle key for a motor vehicle that is configured to receive a request to prevent addition of a newly created digital vehicle key that can be used to control the motor vehicle, and to refuse to sign a newly created vehicle key or store it in the motor vehicle.

The method described herein can be executed, in part or entirely, by the devices described herein, in particular a mobile device, a motor vehicle, or a control unit therein, and/or a key management system. A device may contain a processor for this, which is preferably electronic, and contains an integrated circuit, a programable logic module, or a programmable microcomputer. The method can be a configuration or computer program with programming code for the processor. The configuration or computer program can be stored on a computer-readable memory. Features or advantages of the method can be applied to the device or vice versa.

According to another aspect of the present invention, a system contains the key management system described herein and at least one motor vehicle described herein.

The invention shall now be described in greater detail in reference to the drawings, in which:

### BRIEF DESCRIPTION OF THE DRAWINGS

FIG. 1 shows a system;

FIG. 2 shows a flow chart for a method;

FIG. 3 shows a flow chart for another method; and

FIG. 4 shows a flow chart for yet another method.

### DETAILED DESCRIPTION OF THE DRAWINGS

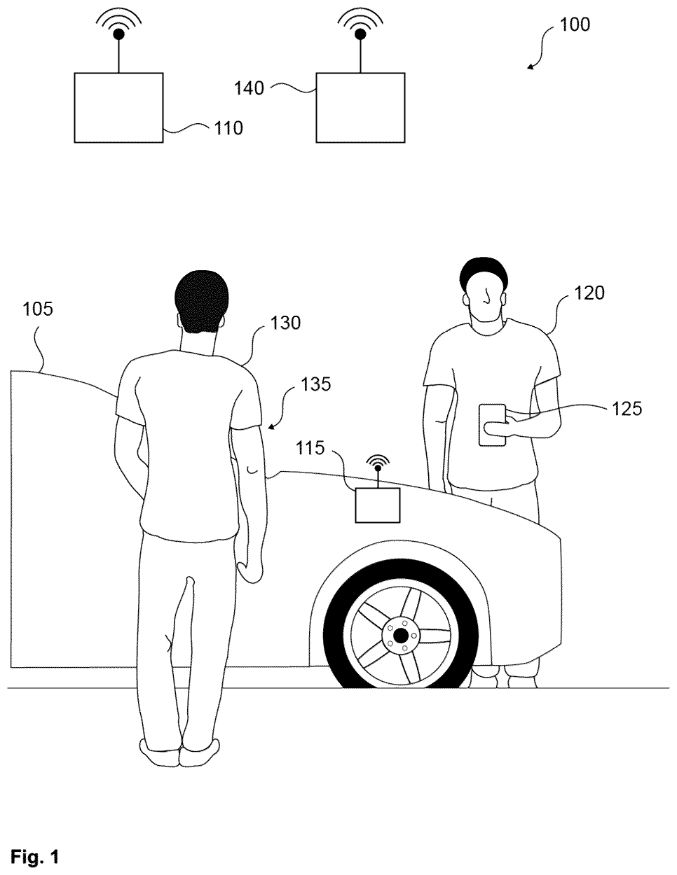

FIG. 1 shows a system 100 that contains a motor vehicle 105 and a key management system 110. The motor vehicle 105 has a control unit 115 configured to control a predetermined function of the motor vehicle 105, in particular a security function, using a digital vehicle key. The security function can be unlocking a door or hatch, deactivation of an immobilizer, or starting a motor.

The fundamental concept of the digital vehicle key preferably complies with the proposals of the Car Connectivity Consortium (CCC). In simple terms, a first person 120 is assigned a specific digital vehicle key, which is normally stored on a first mobile device 125 assigned to the first person 120. The digital vehicle key is also stored in the control unit 115 in the motor vehicle 105. Control of a security function for the vehicle 105 requires cryptographic exchange between the control unit 115 and the mobile device 125. An asymmetrical cryptographic process is preferably used to authentical the communication partner. The digital vehicle key can contain a private component stored on the mobile device 125, and a public component stored in the control unit 115.

The first mobile device 125 could also have a public key for the control unit 115, the corresponding private component of which is only known to the control unit 115. In a so-called standard transaction, mutual authentication of the first mobile device 126 and the control unit 115 can take place. To make the digital key in the first mobile device 125 accessible, the person 120 can first be authenticated by the first mobile device 125, e.g., by presenting a biometric feature or inputting a predetermined code.

A new digital vehicle key can be created and assigned to a second person 130 who has a second mobile device 135 for this. By way of example, it is assumed that the first person 120 is the owner of the motor vehicle 105, and the vehicle key assigned to them authorizes them to issue or sign a newly created vehicle key. The second person 120 is normally referred to as a friend.

The generation process can comprise the key management system 110 digitally signing a newly created digital vehicle key and creating an attestation package containing the signed key, which is then stored in the motor vehicle 105 or control unit 115.

Selectively blocking and later allowing addition of a newly created digital vehicle key to a collection of valid digital vehicle keys that can be used to control the motor vehicle 105 is proposed. Setting and deactivating a lock preventing addition of a newly created vehicle key by the motor vehicle 105 or the control unit 115, and/or by the key management system 110 is particularly preferred.

There can also be a device 140 that can issue a request to the key management system 110 to set a lock. This device 140 can have its own digital vehicle key with which the request can be created. Access to the device 140 can be restricted. By way of example, a person 120, 130 who wants to set or deactivate a lock can establish their legal status authorizing them to take such a step. Authentication can be obtained from another person or automatically from the device 140.

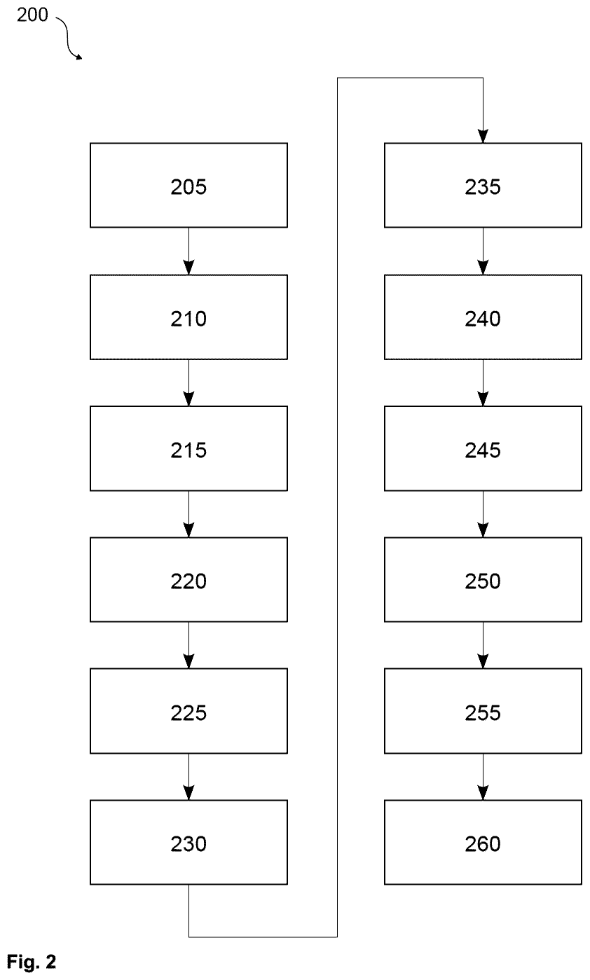

FIG. 2 shows a flowchart for a method for 200 for exiting or participating in a process for creating a key for a motor vehicle 105. Exiting involves setting at least one lock, participating involves deactivating all locks.

It is assumed in step 205 that the motor vehicle 105 is in its initial state regarding control by a digital vehicle key. This state can be assumed when ownership of the vehicle 105 has been transferred to it first owner by the manufacturer.

An owner key can be generated in step 210. This is a digital vehicle key to which authorization for creating and signing a newly created vehicle key is normally assigned. In other words, the first person 120, as owner, can generate or cryptographically sign other digital vehicle keys with their authorization.

Other keys can be generated in step 215, as needed, e.g., for a second person 130. If the collection of digital vehicle keys that can be used to control the motor vehicle 105 corresponds to the expectations of the first person 120, they can represent a request to not add new vehicle keys. The first person 120 can also send a message in this regard to the control unit 115 using their first mobile device 125 and the digital vehicle key stored thereon.

The control unit 115 can check whether a request that has been received contains exit authorization in step 225. At this point, it can be checked whether the digital vehicle key used for creating the request is authorized for this. Authorization of digital vehicle keys is obtained in general before the vehicle key is generated or cryptographically signed.

It can be checked in step 230 whether a collection of valid digital vehicle keys for the motor vehicle 105 contains at least one digital vehicle key with which a newly generated digital vehicle key can later be added. In other words, prior to setting a lock preventing addition of a newly created digital vehicle key for the motor vehicle 105, it can be checked whether certain requirements have been satisfied that would later allow the lock to be deactivated.

A lock can be set in the motor vehicle 105 or control unit 115 in step 235. This lock can prevent acceptance of an attestation package for a newly created digital vehicle key for the motor vehicle 105, or storage of the digital vehicle keys contained therein.

A message can be sent in step 240 from the vehicle 105 to the key management system, with which a lock preventing addition of a digital vehicle key for the motor vehicle 105 is set. This lock can prevent the signing of a digital vehicle key or tracking a key for the motor vehicle 105. It also prevents the sending of an information package regarding a newly created digital vehicle key to the motor vehicle 105, or the control unit 115.

Adding a newly created digital vehicle key to the collection of valid vehicle keys for the motor vehicle 105 is already prevented when just one of the locks is set. Existing digital vehicle keys in the collection can still be used. A digital vehicle key in the collection can also be invalidated while one of the locks is active. In this case, it is important to note that there is always at least one digital vehicle key in the collection that can be used to deactivate the lock.

An existing lock in the motor vehicle 105 and/or the key management system 110 can remain in existence permanently. There can also be a way to later deactivate a lock. A digital vehicle key can be used for this to which a corresponding authorization has been granted.

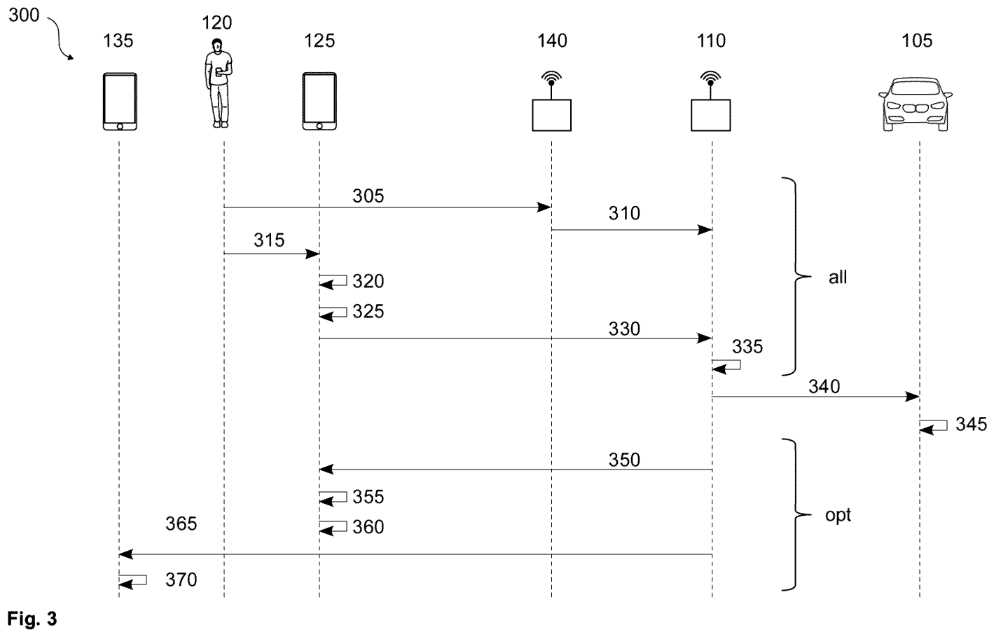

FIG. 3 shows a flow chart for a method 300 for setting a lock preventing addition of a newly created digital vehicle key for the motor vehicle 105. At the start of the method 300, all the participants 105, 110, 120, 125, 135 can be informed that a new digital vehicle key has been created that can be used to control the motor vehicle 105.

A person can 120 can request that a lock be set using the device 140 in step 205. The device can authenticate and/or authorize the person 120 in question for this. Upon authorization, a request to set a lock can be sent in step 310 to the key management system 110. This step corresponds to the third variation described herein for setting a lock.

The person 120 can use the input means in a mobile device 125 in step 315 to activate the lock. The person 120 can authenticate this in step 320. They can also use the input means to prevent an unintentional locking. A request to set a lock using a digital vehicle key stored on the person's 120 mobile device 125 can be created in step 325. The request can be sent to the key management system 110 in step 330. The key management system 110 can set the lock in step 335. This step corresponds to a second variation for setting a lock described herein.

The key management system 110 can check the request to set a lock using the digital vehicle key following step 310 or step 335. When the request has been checked, a request to set a lock can be sent to the motor vehicle 105 in step 340, which can then set the lock in step 345.

Notification of a lock that has been set can be sent in step 350 from the key management system 110 to the person's 110 mobile device 125. The mobile device 110 can show the person 110 on a user interface in step 355 that the lock that has been set, or that it is no longer possible to set a lock. It is also possible to prevent sharing an existing key with another person 130 in step 330.

Similarly, indication of the lock that has been set can be sent from the key management system 110 to a mobile device 135 in step 365. The mobile device 135 is assigned to a person 130 who is not the owner of the motor vehicle 105, or their digital vehicle key does not have the authorization to sign a newly created vehicle key. In step 370, sharing an existing vehicle key with the person 130 can be prevented.

At the end of the method, all the participants 105, 110, 120, 125, 135 can be told that no new digital vehicle keys can be created for the motor vehicle 105.

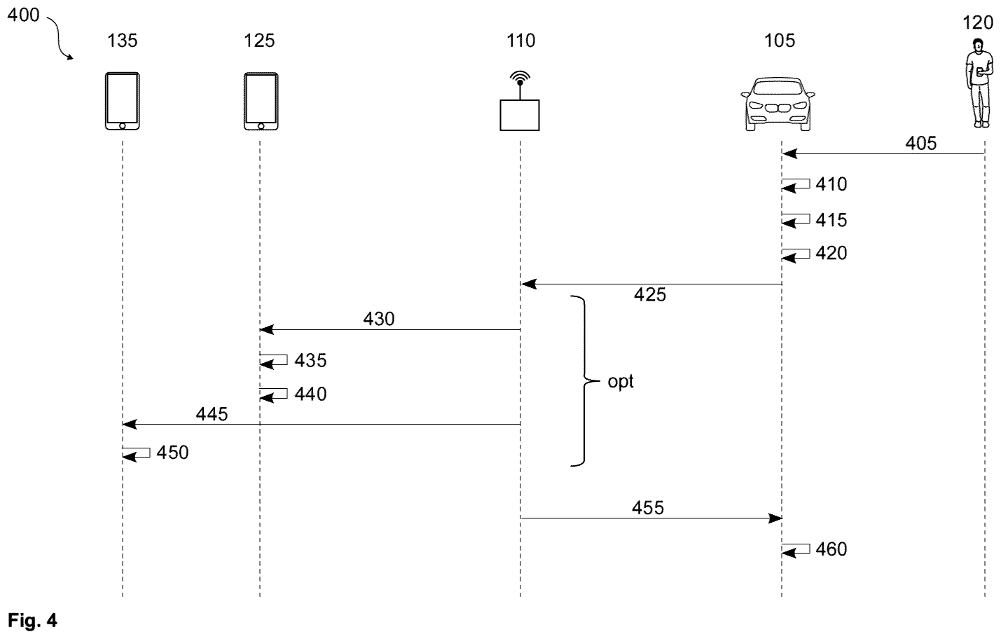

FIG. 4 shows a flow chart for another method 400, with which a first variation for setting a lock described herein can be implemented. In one embodiment, there is a counter in both the motor vehicle 105 and the key management system 110, the reading of which can be advanced when a lock is set. At the start of the method, it is assumed that the readings for the counters in the motor vehicle 105 and key management system 110 are the same.

A person 120 uses the input means in the vehicle to set a lock in step 405. In step 410, the motor vehicle 105 checks for the presence of a mobile device 125 near the motor vehicle 105 and determines that a digital vehicle key stored therein is authorized to set a lock. The lock is set in step 420. The reading on the counter in the motor vehicle 105 can be advanced in step 420. The counters in the motor vehicle 105 and key management system 110 are then no longer synchronized. The motor vehicle can then send a request to set a lock to the key management system 110 in step 425.

The following steps 430 to 450 are optional and correspond to the steps 350 to 370 described above in reference to FIG. 3.

The key management system 110 can advance the reading in its counter in step 455. In one embodiment, the motor vehicle 105 has sent its reading in step 425 and the key management system 110 sets its own reading on the basis thereof. Confirmation of the lock, as well as indicating the current reading of the counter for the key management system 110 can be sent to the motor vehicle 105 in step 455. The reading for the counter in the motor vehicle 105 can be compared with the reading for the counter in the key management system 110 in step 460 and adjusted to one another if necessary. The counters in the motor vehicle 105 and the key management system 110 are then synchronized.

### REFERENCE SYMBOLS

100 system
105 motor vehicle
110 key management system
115 control unit
120 first person (owner)
125 first mobile device
130 second person (friend)
135 second mobile device
140 device
200 method
205 motor vehicle is new
210 generation of owner key
215 potential other keys generated
220 request to exit received
225 request authorized?
230 vehicle key for participating exists?
235 lock vehicle
240 request to participate received, authorization checked
250 unlock vehicle
255 unlock key management system
260 synchronization
300 method
305 create request for lock
310 request setting of a lock (proprietary message)
315 input: set lock
320 confirmation and authentication of the person
325 generate request to set lock
330 send request
335 check request
340 send request to set lock
345 set lock
350 send indication of set lock
355 deactivate operating element for setting a lock
360 sharing of key prevented
365 send indication that lock has been set
370 sharing of key prevented
400 method
405 input: set lock
410 check presence and authorization of digital key
415 set lock
420 advance counter reading, counters desynchronized
425 send request
430 send indication of set lock
435 deactivate operating element for setting lock
440 send indication that lock is set
450 sharing of keys prevented
455 advance counter reading, send confirmation of set lock
460 vehicle locked, counters synchronized

What is claimed is:

1. A method for controlling a motor vehicle, the method comprising:
detecting a request to prevent addition of a newly created digital vehicle key that can be used to control the motor vehicle;
determining that the request uses an existing and authorized digital vehicle key; and
setting a lock that prevents validation of the newly created vehicle key or prevents storage of the newly created vehicle key in the motor vehicle.

2. The method according to claim 1, wherein the lock prevents storage of the newly created digital vehicle key in the motor vehicle.

3. The method according to claim 1, wherein the lock prevents signing the newly created digital vehicle key by a key management system.

4. The method according to claim 2, wherein the lock prevents signing the newly created digital vehicle key by a key management system.

5. The method according to claim 3, wherein the lock prevents issuing of an attestation package for the newly created digital vehicle key by the key management system.

6. The method according to claim 4, wherein the lock prevents issuing of an attestation package for the newly created digital vehicle key by the key management system.

7. The method according to claim 1, wherein it is determined that at least one digital vehicle key exists for controlling the motor vehicle with which the lock can be deactivated.

8. The method according to claim 1, wherein the request is issued in response to a direct interaction with the motor vehicle.

9. The method according to claim 2, wherein the request is issued in response to a direct interaction with the motor vehicle.

10. The method according to claim 1, wherein the request is issued in response to an input entered in a device on which the authorized digital vehicle key is stored.

11. The method according to claim 2, wherein the request is issued in response to an input entered in a device on which the authorized digital vehicle key is stored.

12. The method according to claim 1, wherein the request is issued by a central office.

13. The method according to claim 2, wherein the request is issued by a central office.

14. The method according to claim 1, wherein the motor vehicle rejects a digital vehicle key after setting the lock on the vehicle and prior to deactivating the lock.

15. The method according to claim 14, wherein a key management system and the motor vehicle each have a counter that advances when the lock is set, wherein the key management system assigns a current reading of its counter to a digital vehicle key that is to be stored, and wherein the motor vehicle refuses to store a digital vehicle key that has a lower reading than the current reading for the counter in the motor vehicle.

16. A mobile device for controlling a motor vehicle, the mobile device comprising:
a user interface for entering a request to prevent addition of a newly created digital vehicle key that can be used to control the motor vehicle;
a communication system for communicating with a key management system or the motor vehicle;
a protected memory in which an existing digital vehicle key for the motor vehicle is stored; and
a processor configured to receive an input and to provide a request to set a lock on the key management system and/or the motor vehicle in response to the input, using the existing digital vehicle key, to prevent validation of a newly created digital vehicle key or storage of the newly created digital vehicle key in the motor vehicle.

17. A device for controlling a motor vehicle, the device comprising:
a user interface for inputting a request to prevent addition of a newly created digital vehicle key that can be used to control the motor vehicle;
an interface for communicating with a mobile device on which an existing digital vehicle key for the motor vehicle is stored; and
a processor configured to check the digital vehicle key and to prevent storage of the newly created digital vehicle key in the motor vehicle.

18. A motor vehicle comprising a device according to claim 17.

19. A key management system for a digital vehicle key for a motor vehicle, wherein the key management system is configured to receive a request to prevent addition of a newly created digital vehicle key that can be used to control the motor vehicle, and to refuse to sign the newly created digital vehicle key or store the newly created digital vehicle key in the motor vehicle.

20. A system comprising a key management system according to claim 14 and a motor vehicle including a device for controlling the motor vehicle, wherein the device includes a user interface for inputting a request to prevent addition of a newly created digital vehicle key that can be used to control the motor vehicle; an interface for communicating with a mobile device on which an existing digital vehicle key for the motor vehicle is stored; and a processor configured to check the digital vehicle key and to prevent storage of the newly created digital vehicle key in the motor vehicle.
